(19) United States
(12) Patent Application Publication
(10) Pub. No.: US 2026/0253602 A1
(43) Pub. Date: Aug. 27, 2026

(54) COMMUNICATION QUALITY EVALUATION APPARATUS, COMMUNICATION QUALITY EVALUATION METHOD, AND PROGRAM

(71) Applicant: NTT, Inc., Tokyo (JP)

(72) Inventors: Sachiko KURIHARA, Tokyo (JP); Noboru HARADA, Tokyo (JP); Masahiro FUKUI, Tokyo (JP)

(73) Assignee: NTT, Inc., Tokyo (JP)

(21) Appl. No.: 18/862,496

(22) PCT Filed: May 12, 2022
(86) PCT No.: PCT/JP2022/020056

§ 371 Date: Nov. 1, 2024

(51) Int. Cl. G10L 25/60

(52) U.S. Cl. CPC G10L 25/60

(57) ABSTRACT

There is provided a communication quality evaluation apparatus including: an Equipment impairment factor Ie computing unit that computes an Equipment impairment factor Ie in a Rating factor R calculating expression of the E-model based on an assessment result obtained by assessing test speech sound by an subject based on DCR or ITU-R BS.1116 based on a subjective evaluation scale including both words indicating a difference in the test speech sound from reference speech sound and words indicating listening easiness of the test speech sound; and a Rating factor R computing unit that computes a Rating factor R of the E-model based on the computed Equipment impairment factor Ie.

### TECHNICAL FIELD

The present invention relates to a communication quality evaluation apparatus, a communication quality evaluation method, and a program which estimate speech quality of loudspeaker communication system with the E-model.

### BACKGROUND ART

For a quality assessment indicator of IP phone communication service, there is the E-model assessment method for estimating a subjective evaluation value (conversational MOS) from a subjective evaluation value (listening MOS) for an output signal of a speech signal processing device or a subjective evaluation value (listening MOS) estimated from a physical measurement result (Non Patent Literature 1).

### CITATION LIST

### Non Patent Literature

Non Patent Literature 1: “JJ-201.01, A Method for Speech Quality Assessment of IP telephony”, Ninth edition, The Telecommunication Technology Committee, Aug. 29, 2018

### SUMMARY OF INVENTION

### Technical Problem

According to the method in Non Patent Literature 1, it is possible to apply the method to quality assessment of IP phone communication services by setting the sound quality of speech sound as an assessment target without considering a delay or a line echo having a low influence on the quality. However, in a case where speech sound affected by an acoustic echo is an assessment target, such as in a hands-free loudspeaker speech used in a vehicle interior or a remote conference, it is difficult to apply this method to the subjective evaluation of an acoustic echo which is returned speech sound, because an acoustic echo is not easily perceived except by the person making the call, and an acoustic echo, which is assumed to be unnecessary speech sound, cannot be recognized as noise and cannot be appropriately assessed unless distorted.

In this respect, an object of the present invention is to provide a communication quality evaluation apparatus capable of estimating sound quality of a loudspeaker speech system with the E-model.

### Solution to Problem

A communication quality evaluation apparatus of the present invention includes an Equipment impairment factor Ie computing unit and a Rating factor R computing unit. The Equipment impairment factor Ie computing unit computes an Equipment impairment factor Ie in a Rating factor R calculating expression of the E-model based on an assessment result obtained by assessing test speech sound by an subject based on a DCR or ITU-R BS.1116 based on a subjective evaluation scale including both words indicating a difference in the test speech sound from reference speech sound and words indicating ease of listening of the test speech sound. The Rating factor R computing unit computes a Rating factor R of the E-model based on the computed Equipment impairment factor Ie.

### Advantageous Effects of Invention

According to a communication quality evaluation apparatus of the present invention, the sound quality of a loudspeaker speech system can be estimated with the E-model.

### BRIEF DESCRIPTION OF DRAWINGS

FIG. 1 is a diagram illustrating the E-model and a Rating factor R.

FIG. 2 is a table illustrating categories used for evaluation.

FIG. 3 is a table illustrating factors of speech quality degradation related to AEC processing.

FIG. 4 is a table illustrating test conditions of the AEC processing by a computing machine simulation.

FIG. 5 is a graph illustrating a result of listening test which is a result of an evaluation test.

FIG. 6 is a graph illustrating a result of PESQ which is a result of an evaluation test.

FIG. 7 is a graph illustrating a relationship between listening test and PESQ which are results of an evaluation test.

FIG. 8 is a table illustrating a relationship between an AEC processing degree and a received speech sound.

FIG. 9 is a table illustrating test conditions of an AEC-processed speech Signal by an actual machine.

FIG. 10 is a graph illustrating a result of DCR test which is a result of an evaluation test.

FIG. 11 is a graph illustrating a relationship between PESQ and DCR which is a result of an evaluation test.

FIG. 12 is a block diagram illustrating a configuration of the E-model assessment system of Example 1.

FIG. 13 is a flowchart illustrating an operation of the E-model assessment system of Example 1.

FIG. 14 is a diagram for illustrating Ie, eff, and other parameters of a Rating factor R of the E-model.

FIG. 15 is a diagram illustrating a functional configuration example of a computer.

### DESCRIPTION OF EMBODIMENTS

Hereinafter, embodiments of the present invention will be described in detail. Note that components having the same functions are denoted by the same reference numerals, and redundant description will be omitted.

### <Technique of Assessing Quality for Loudspeaker Speech>

Hereinafter, in view of general assessment methods for IP phones as techniques for assessing speech quality, the differences and similarities in a speech environment between handset speeches and loudspeaker speeches will be clarified based on differences in parameters based on the E-model. A result of studying an effective listening test method for a loudspeaker speech based on the E-model for estimating a conversational MOS based on a listening MOS in quality evaluation of an IP phone will be described.

### <<Technique of Assessing Quality for IP Phone>>

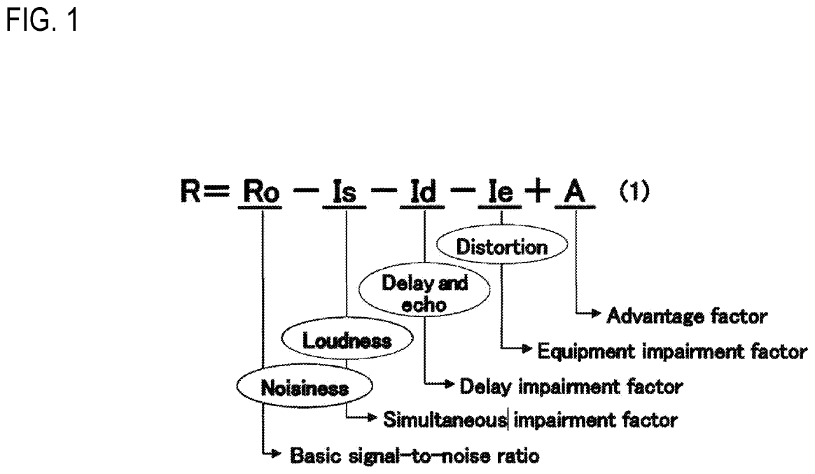

Regarding IP phones, a conversation test for assessing overall quality and a listening test focusing only on speech quality are performed, and a conversational MOS can be estimated based on the listening MOS by using Calculation Expression (1) of the E-model illustrated in FIG. 1 (Reference Non Patent Literature 1 and Reference Non Patent Literature 2).
(Reference Non Patent Literature 1: ITU-T Recommendation G.107, “The E-model: a computational model for use in transmission planning”, June 2015.)
(Reference Non Patent Literature 2: Akira Takahashi, Hideaki Yoshino, and Nobuhiko Kitawaki, “Quality Assessment Methodologies for IP-Telephony Services”, The Transactions of the Institute of Electronics, Information and Communication Engineers. B, Vol. J88-B, No. 5, pp. 863-874, 2005.)

The E-model is a model developed for the purpose of checking actual service quality based on a circuit switching technology and is configured of five psychological factor parameter groups (noisiness: noise feeling, loudness: volume feeling, delay and echo: delay/echo feeling, distortion: speech quality feeling, advantage factor: convenience) illustrated in FIG. 1.

A Rating factor R is used to estimate a conversational MOS, and it is common to use an actual measurement value for the distortion and the delay and echo and defined values for parameters other than the distortion and the delay and echo (Reference Non Patent Literature 1 and Reference Non Patent Literature 2).

Initially, it was considered that the E-model is difficult to apply to IP phones, but in Japan, the use of the E-model using the listening test has been recommended by the Telecommunication Technology Committee (TTC) as “quality factors to be considered in provision of the IP phone service are speech quality, delay, and line echo, and it is desirable to assess actual speech quality from the viewpoint of checking quality of an actual service” (Non Patent Literature 1).

Here, the distortion is a condition caused by an encoding process, and the delay and echo is a condition caused by a network. Further, the TTC sets “ensuring and implementing that there is no fluctuation or packet loss other than an intentionally inserted delay” as a network condition in a listening test (Non Patent Literature 1), and in response to this, the listening test is generally conducted as a test which is “not influenced by a network” by further simplifying the condition. Among conditions caused by a network, for example, the delay has no influence on quality unless in a conversation test, and the echo (line echo) gives an impression similar to that of a sidetone of a phone and has little influence on quality if the delay is sufficiently short (Non Patent Literature 1). Further, although the packet loss has a large influence on speech quality degradation, it is not necessary to consider the packet loss here because the packet loss is included in assessment criteria conditions of the encoding process. Therefore, for the IP phone, it is assumed that there is no network influence, and thus only the distortion (particularly, speech sound subjected to encoding processing) is an assessment target.

### <<Proposal of Technique of Assessing Quality for Loudspeaker Speech>>

In order to estimate overall quality of loudspeaker speech by the E-model, it is desirable to use only the distortion (AEC-processed speech sound including encoding process) of parameters related to the listening test, similarly to the IP phone. The largest difference between speech conditions of the loudspeaker speech and the IP phone is the presence of “acoustic echo”. A condition or line echo caused by a network can be set to have no influence on the quality similarly to the IP phone, but the acoustic echo is a condition that significantly affects the quality in assessing the loudspeaker speech and cannot be ignored.

In the present specification, the acoustic echo in the listening test is assumed to be “interference speech sound by a third person”. Therefore, it is proposed that the acoustic echo is subjected to speech quality assessment together with the distortion, and validity of the assessment is theoretically confirmed. Similarly to the assessment of the IP phone, it is assumed that there is no influence of the network, and then speech quality of an AEC-processed speech sound including the encoding process is assessed. In the listening test, in order to treat an acoustic echo as distortion, selection and devising of an assessment method are important. In the IP phone, generally, an absolute category rating (ACR), Reference Non Patent Literature 3), which is also called MOS test, is used, and the listening MOS estimated by PESQ is also a result of ACR.
(Reference Non Patent Literature 3: ITU-T Recommendation P.800, “Methods for subjective de-termination of transmission quality”, August 1996.)

The ACR can be defined to be a technique suitable for assessment of speech quality because the ACR assesses the impression of the subject as it is. However, in a case where “a received speech sound on which the acoustic echo is superimposed” is assessed by the ACR, there is a possibility that the acoustic echo, which is assumed to be unnecessary speech sound, will not be recognized as noise and will be assessed with high accuracy unless distorted. This is why it has been reported that it is difficult to detect an acoustic echo unless it is a conversation test. In order to realize assessment of a loudspeaker speech in a listening test, it is necessary to devise to cause the subject to detect the “acoustic echo”.

In the present specification, a method of detecting an acoustic echo has been studied with reference to an official test in a test laboratory when an speech codec which is a main quality of the IP phones is recommended as ITU-T International Standards G.729 (Reference Non Patent Literature 4) and G.711.1 (Reference Non Patent Literature 5).
(Reference Non Patent Literature 4: ITU-T Recommendation G.729, “Coding of speech at 8 kbit/s using conjugate-structure algebraic-code-excited linear prediction (CS-ACELP)”, June 2016.)
(Reference Non Patent Literature 5: ITU-T Recommendation G.711.1, “Wideband embedded extension for ITU-T G.711 pulse code modulation”, September 2012.)

In an official test, the ACR is used for the assessment of a basic performance and the clean speech, but a degradation category rating (DCR, Reference Non Patent Literature 3), ITU-R BS.1116 (double-blind triple-stimulus with hidden reference, Reference Non Patent Literature 6), and the like are often used for a target which has a score tending to be biased downward/upward in a condition where ambient noise is superimposed, an speech codec requiring high quality performance, or the like (Reference Non Patent Literature 7).
(Reference Non Patent Literature 6: ITU-R Recommendation BS.1116-3, “Methods for the subjective assessment of small impairments in audio systems”, February 2015.) (Reference Non Patent Literature 7: Sachiko Kurihara, Akitoshi Kataoka, Shinji Hayashi, Takao Kaneko, ITU-T G.729 Quality Assessment for Extending ITU-T G.729 Annexes”, The Transactions of the Institute of Electronics, Information and Communication Engineers D-II 87(2), pp. 416-426, 2004.)

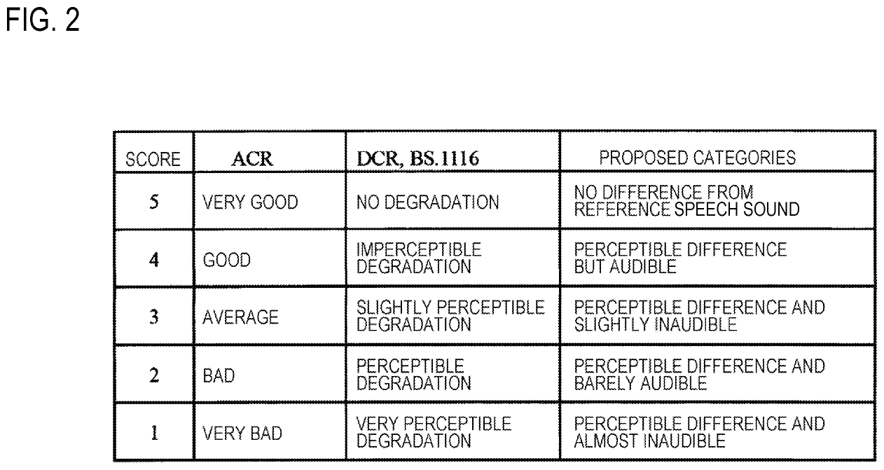

The DCR is a method added to ITU-T P.800 for the purpose of enhancing the assessment accuracy of conditions in which hardly any differences are found in the ACR, and BS.1116 is a method for assessing the DCR with higher accuracy. Since the DCR and BS.1116 performs assessment by comparing reference speech sound (ideal speech sound) and an assessment target speech sound (received speech sound) similarly to PESQ, it is possible to detect a speech quality difference that is unlikely to be detected by the ACR. An obtained result is a degradation mean opinion score (DMOS, Reference Non Patent Literature 3) and indicates a quality difference from the reference speech sound. FIG. 2 illustrates categories used for the ACR, the DCR, and BS.1116.

The ACR, the DCR, and BS.1116 disclosed herein use categories with five levels with the same meaning. When the assessment method is changed, an evaluation range is also changed, but all the categories are ordinal scales, and unless comparison is performed between different assessment methods, assignment or a quality difference is reflected as it is without a change in superiority and inferiority of the speech quality irrespective of the assessment method being used. Even in an official test when an speech codec which is a main quality of IP phones was recommended in the ITU-T international standards, the ACR, the DCR, and BS.1116 was employed in accordance with assessment conditions (Reference Non Patent Literature 7 and Reference Non Patent Literature 8).
(Reference Non Patent Literature 8: ITU-T SG 12 Q.7/12 Rapporteurs, “Superwideband extension to G.711.1 and G.722 Qualification Quality Assessment Test Plan”, October 2008.)

In the case where normal speech quality is assessed, the DCR for general subjects is used, but for an assessment target having a small speech quality difference, BS.1116 for an expert listener capable of detecting even a minute difference with high accuracy is often used (Reference Non Patent Literature 7 and Reference Non Patent Literature 8).

By following the examples, either the DCR or BS.1116 is proposed to be employed in a listening test for a loudspeaker speech. By using speech sound uttered by a far-end speaker as reference speech sound and comparing the speech sound with the reference speech sound, even if the acoustic echo is an articulate speech sound without distortion, the acoustic echo can be determined as unnecessary speech sound if the acoustic echo is superimposed.

Here, in consideration of consistency with PESQ, an evaluation result for a “satisfaction level (ease of listening) for speech quality” as obtained from the ACR is required. In this respect, in order to obtain a result focusing on “ease of listening” while assessment is performed with a DCR or BS.1116 capable of presenting reference speech sound, a unique category illustrated in FIG. 2 is proposed. In the present specification, a relationship with PESQ is confirmed as a method for assessing a loudspeaker speech in a listening test, including a change from ACR to DCR and BS.1116.

### <Quality Assessment for AEC-Processed Speech Sound Created by Computing Machine Simulation>

### <<AEC-Processed Speech Sound by Computing Machine Simulation>>

Here, in order to confirm the effectiveness of the listening test and PESQ evaluation for the loudspeaker speech proposed in <Technique of Assessing Quality for Loudspeaker Speech> and the relationship between the proposed listening test and PESQ evaluation, a speech quality evaluation test is performed on the AEC-processed speech sound created by a computing machine.

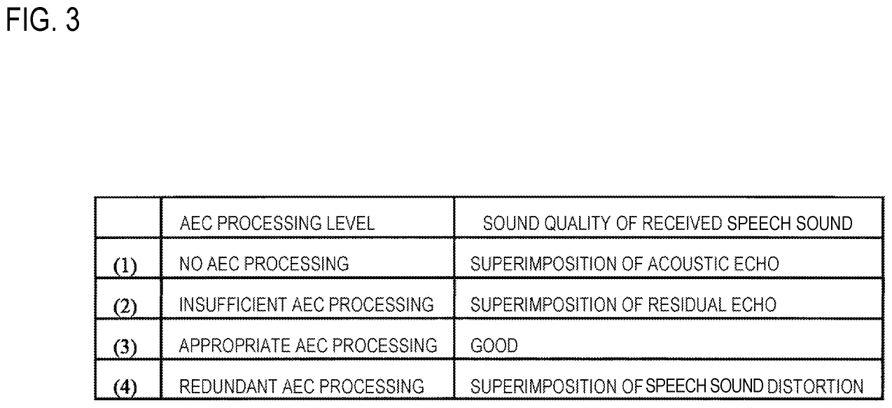

The speech sound used in the test is based on the assumption of “no AEC processing” and including “AEC processing (insufficient/appropriate/redundant)” of speech quality degradation factors related to the AEC processing illustrated in FIG. 3, and is in a condition of double talk in which “speech sound distortion” and “residual echo” are superimposed in a stagewise manner by a computing machine by using two general degradation scales of a Signal to Distortion Ratio (SDR) and a Signal to Echo Ratio (SER, Reference Non Patent Literature 9) as objective evaluation scales of the AEC processing.
(Reference Non Patent Literature 9: M. Fukui, S. Shimauchi, and A. Nakagawa, “Convolutive residual echo power estimation for acoustic echo reduction”, Journal of Signal Processing, vol. 24, no. 6, pp. 237-245, November 2020.)

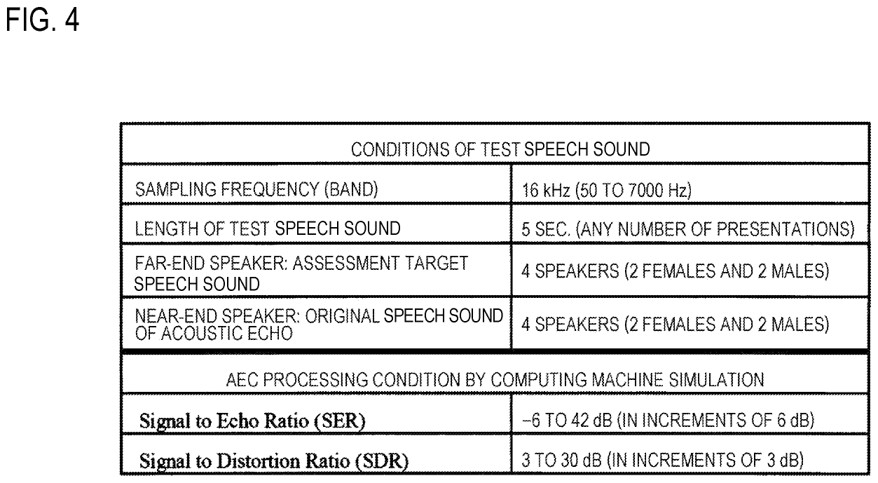

As illustrated in FIG. 4, a target is 90 conditions obtained by combining all of nine conditions of SERs: −6 to 42 dB (in increments of 6 dB) and ten conditions of SDRs: 3 to 30 dB (in increments of 3 dB). Expressions used for the processing are shown in (2) and (3).

$$\begin{matrix}[ Math . 1 ] & \\ SER = 10 {log}_{10} {\sum }_{i = 0}^{L - 1} {\sum }_{ω = 0}^{M - 1} \frac{{\vert {S}_{i} ( ω ) \vert}^{2}}{LM {\vert {G}_{i} ( ω ) {D}_{i} ( ω ) \vert}^{2}} & ( 2 )\end{matrix}$$

$$SDR = 10 {log}_{10} {\sum }_{i = 0}^{L - 1} {\sum }_{ω = 0}^{M - 1} \frac{{\vert {S}_{i} ( ω ) \vert}^{2}}{LM {\vert {S}_{i} ( ω ) - {G}_{i} ( ω ) {S}_{i} ( ω ) \vert}^{2}} \qquad ( 3 )$$

Here, Sᵢ(ω) represents a speech signal emitted by a far-end speaker, Dᵢ(ω) represents a residual echo amount, L represents a frame number, and M represents a frequency bin number. This simulation is a simulation assuming a received speech sound subjected to the AEC processing (insufficient/appropriate/redundant) (AEC-processed speech sound by a computing machine simulation). An echo suppression amount and a speech transmission distortion amount are controlled by a gain Gᵢ(ω), and specific AEC processing is not implemented.

In an evaluation test, it is necessary to prepare test speech sound in which speech quality (score 5) that everyone thinks good at listening and speech quality (score 1) that everyone thinks bad at listening are mixed. In this respect, in addition to an AEC-processed speech sound by a computing machine simulation, assessment targets include “speech sound uttered by a far-end speaker (ideal speech sound)” set as a condition of speech quality that everyone thinks good at listening and “speech sound on which an acoustic echo that is not subjected to AEC processing is superimposed” set as a condition of speech quality that everyone thinks bad at listening.

### <<Quality Evaluation of AEC-Processed Speech Sound Created by Computing Machine Simulation>>

In order to cause an subject to detect an acoustic echo, the DCR/BS.1116 for performing evaluation by comparing with reference speech sound is proposed to be employed as a listening test for a loudspeaker speech in <Technique of Assessing Quality for Loudspeaker Speech>.

Here, the test speech sound as the assessment target is created by processing values of the SER and the SDR in increments of 6 dB and 3 dB, respectively, by a computing machine simulation, and a quality difference of speech sounds is small. In this respect, BS.1116 for an expert listener capable of detecting a difference finer than that in the DCR (Reference Non Patent Literature 8) is used. The BS.1116 is a technique of listening and comparing three speech sounds of reference speech sound (ideal speech sound), hidden reference speech sound (the same speech sound as the reference speech sound), and an assessment target speech sound (received speech sound) many times until an subject is satisfied, identifying the hidden reference speech sound, and assessing the speech sounds in increments of 0.1 using the same five degradation categories as those of the DCR. Usually, in BS.1116, a difference value between the reference speech sound (5 points) and a score given by the subject is used as the evaluation value, but in the present specification, the very score given by the subject is accepted as the evaluation value similarly to the DCR since the purpose of implementation is also to investigate a relationship with PESQ evaluation.

The speech sound used in the test has 368 conditions of four speakers (two females and two males)×(SER: nine conditions×SDR: ten conditions+ideal speech sound (score 5)+speech sound on which the acoustic echo that is not subjected to the AEC processing is superimposed (score 1)). The subjects were 64 ordinary people, and the number of subjects was set to 2.5 times the normal number in order to obtain the same level of assessment accuracy as that of the expert listener with reference to the official test (Reference Non Patent Literature 5 and Reference Non Patent Literature 8) of G.711.1 in the test laboratory when the speech codec, which is the main quality of the IP phones, was recommended as ITU-T International Standards G.729 and G.711.1. In addition, in conducting the evaluation test, an order of presentation of the test speech sounds is an important condition. Since there is a possibility that the score will change depending on which timing the test speech sounds come out, the test speech sounds were presented randomly, and evaluations were performed in a presentation order different for each subject set (set of four persons).

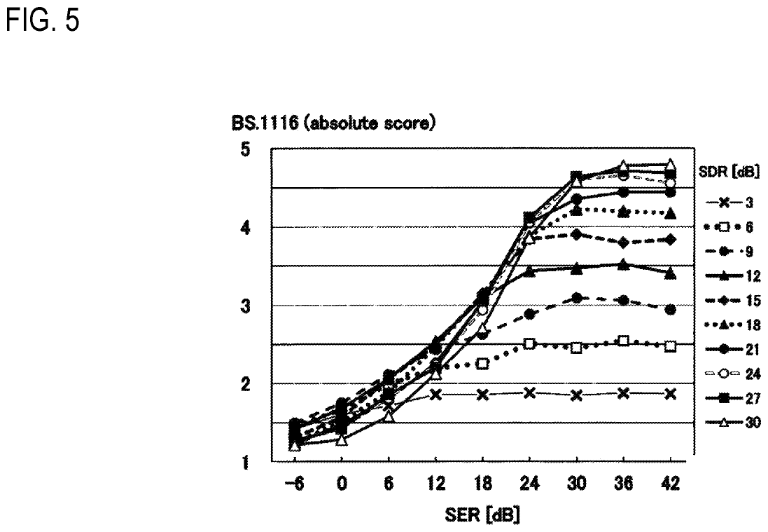

FIGS. 5 to 7 illustrate results of a proposed listening test and PESQ for AEC-processed speech sound. Items of data plotted here are AEC-processed speech sound in 90 conditions (SER: nine conditions×SDR: ten conditions) created by a computing machine simulation, and each point represents an average value of 256 data (four speakers×64 subjects).

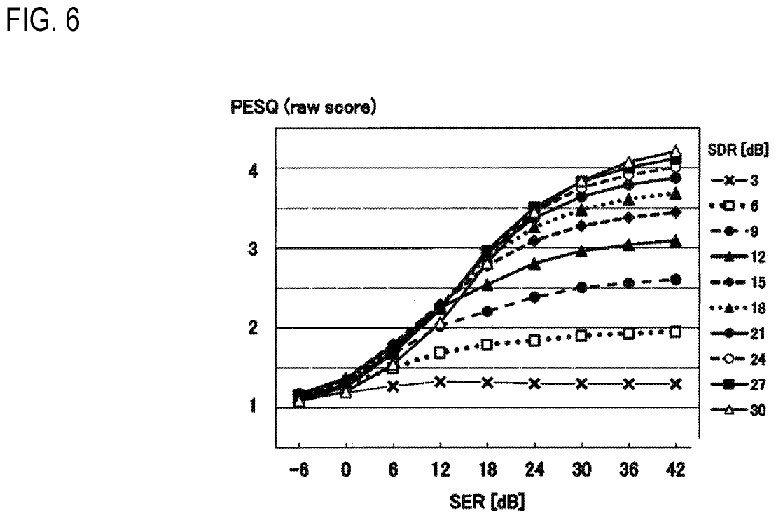

FIG. 5 illustrates a result of a listening test by BS.1116, and FIG. 6 illustrates a result of PESQ evaluation. Here, the vertical axis represents the evaluation value, the horizontal axis represents the SER, and each broken curve represents the SDR. In the view of the graphs, the vertical axis indicates quality, and the higher the value, the higher the quality. FIG. 5 illustrates evaluation values of BS.1116 (the very scores given by the subjects), and FIG. 6 illustrates PESQ evaluation values (raw scores). The horizontal axis SER and the broken curves SDR are conditions related to speech quality, and the higher the value, the higher the speech quality. In theory, a combination of SER: 42 dB and SDR: 30 dB is the highest speech quality condition, and a combination of SER: −6 dB and SDR: 3 dB is the lowest speech quality condition.

It can be found that the results of listening test and PESQ evaluation by BS.1116 both have similar tendencies, and as in theory, the higher the values of both the SER and the SDR, the higher the assessment is obtained. Subjective evaluation values by the listening test does not form a smooth line as compared with the PESQ evaluation values, but it is presumed that the test speech sounds used here have a small quality difference and are difficult to assess.

In the result of BS.1116 in FIG. 5, an order of subjective quality evaluation values corresponding to the SDR and the SER is not changed, and thus, a result that is not contradictory to a premise that an assumption that an “acoustic echo” in a loudspeaker speech can be regarded as the same condition as an “interference speech sound by a third person which is superimposed on a far end terminal” in the IP phone is established by the proposal method was obtained.

Similarly, in the PESQ evaluation result in FIG. 6, a result that is not contradictory to a premise that an assumption that the “acoustic echo” in the loudspeaker speech can be regarded as the same condition as “speech transmission-side ambient noise” in the IP phone is established was obtained.

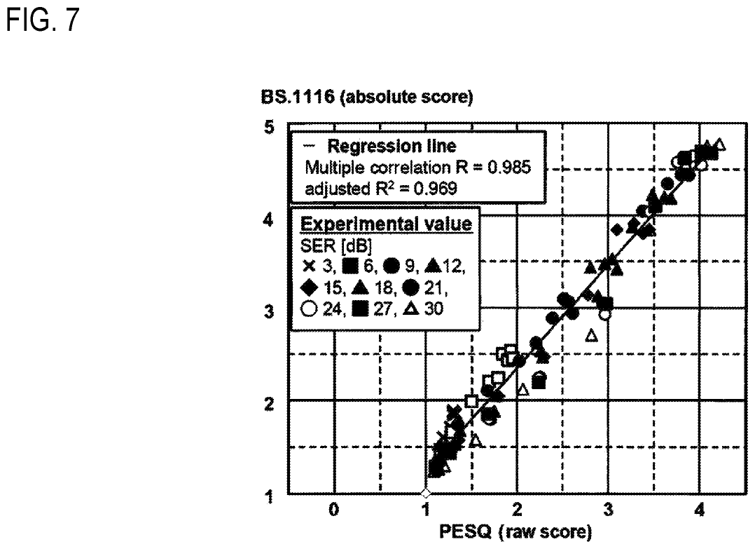

FIG. 7 illustrates a relationship between the subjective evaluation value by the listening test and the PESQ evaluation value according to BS.1116. Here, the vertical axis represents the evaluation values of BS.1116 (the very scores given by the subjects), and the horizontal axis represents the PESQ evaluation values (raw scores). Individual items of plotted data indicate actual measured values of the subjective evaluation values by listening test and the PESQ evaluation values according to BS.1116, and the solid line indicates estimation values (regression line) calculated by the regression analysis.

From the results of the evaluation test, an adjusted coefficient R² of determination of an estimation model (hereinafter, BS.1116 estimation model) with respect to the subjective evaluation values by the listening test (actual measured values of BS.1116) and the PESQ evaluation values was 0.97. This indicates that the BS.1116 estimation model is consistent with the measured value by 97%, and it was confirmed that 97% of the proposed listening test BS.1116 can be explained by PESQ.

As illustrated in the drawing, the relationship between the subjective evaluation values by the listening test and the PESQ evaluation values can be approximated by a linear function of Fy=a·x+b. Here, x represents a PESQ value, y represents a

subjective evaluation value by the listening test, a represents 1.3 or a value approximate to 1.3, and b represents −0.3 or a value approximate to −0.3. A value approximate to α means a value belonging to a range of α−δ₁ or more and α−δ₂ or less. Here, δ₁ and δ₂ are positive values, and δ₁=δ₂ may be satisfied, or δ₁≠δ₂ may be satisfied. Examples of δ₁ and δ₂ are values of 10% or 20% of |α|. For example, a=1.33 and b=−0.27.

From the results of this test, as a result of performing the proposed listening test (BS.1116) and PESQ evaluation on the AEC-processed speech sound in which the “speech sound distortion” and the “acoustic echo” and the “residual echo (unremoved residual acoustic echo)” were superimposed in a stagewise manner by the computing machine, a result without contradiction with an assumption which is the premise of the proposed listening test was obtained. In addition, it was confirmed that BS.1116 estimation model estimates the measured value of BS.1116 with very high accuracy.

### <Quality Assessment of AEC-Processed Speech Sound by Actual Machine>

### <<AEC-Processed Speech Sound by Actual Machine>>

Here, in order to check the effectiveness and relationship of the proposed listening test and PESQ evaluation which are examined in <Technique of Assessing Quality for Loudspeaker Speech> and performed in <Quality Assessment for AEC-Processed speech sound Created by Computing Machine Simulation>, the assessment target is amplified to a “loudspeaker speech sound (AEC-processed speech sound) by the actual machine”, and the proposed listening test and the evaluation test by PESQ are performed. The test speech sounds used here are “received speech sound of a two-way call” recorded in advance using seven models of communication devices.

Speakers were four far-end speakers who uttered the assessment target speech sound and four near-end speakers who uttered original speech sound of the acoustic echoes, and the far-end speakers and the near-end speakers were of the opposite sex in order to facilitate discrimination between the acoustic echoes. Utterance conditions include three conditions of a single talk and two types of double talk (mixed speech sound of the far-end speaker and the near-end speaker).

In the listening test, it is necessary to prepare test speech sound in which speech quality (score 5) that everyone thinks good at listening and speech quality (score 1) that everyone thinks bad at listening are mixed. However, here, since an actual machine recorded speech sound is a target, it is not possible to prepare test speech sounds with various variations such as those in <Quality Assessment for AEC-Processed speech sound Created by Computing Machine Simulation>. In this respect, in addition to the AEC-processed speech sound by the actual machine, assessment targets include “a received speech sound of the single talk which is not subjected to the AEC processing” set as a condition of speech quality that everyone thinks good at listening and “a received speech sound of double talks on which an acoustic echo that is not subjected to the AEC processing is superimposed” set as a condition of speech quality that everyone thinks bad at listening.

The speech quality varies depending on each communication device, but theoretically, the condition of “the received speech sound of the single talk which is not subjected to the AEC processing” is the highest speech quality condition, and the condition of “the received speech sound of the double talks on which an acoustic echo that is not subjected to the AEC processing is superimposed” is the lowest speech quality condition.

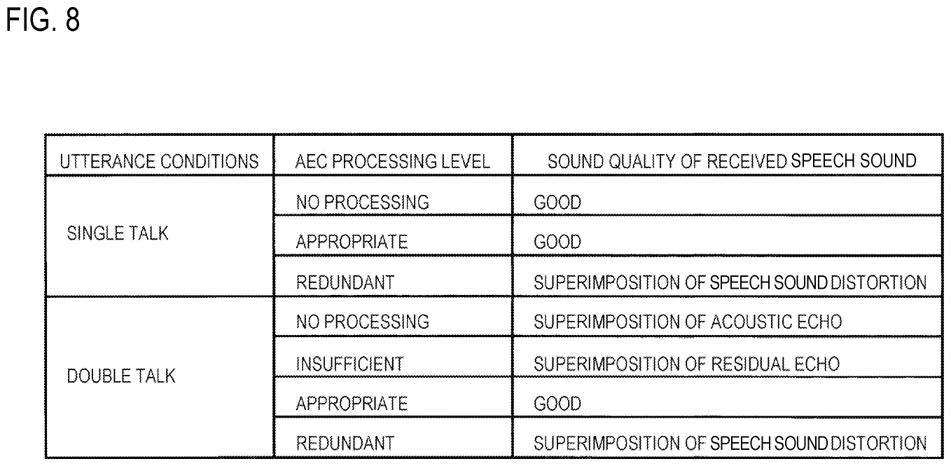

FIG. 8 is a table illustrating a relationship between an AEC processing degree and the speech quality of a received speech sound. Note that the relationship between the AEC processing and the speech quality described in the drawing is a speech quality image aimed at in planning this test and does not indicate the speech quality itself of the test speech sound of this test.

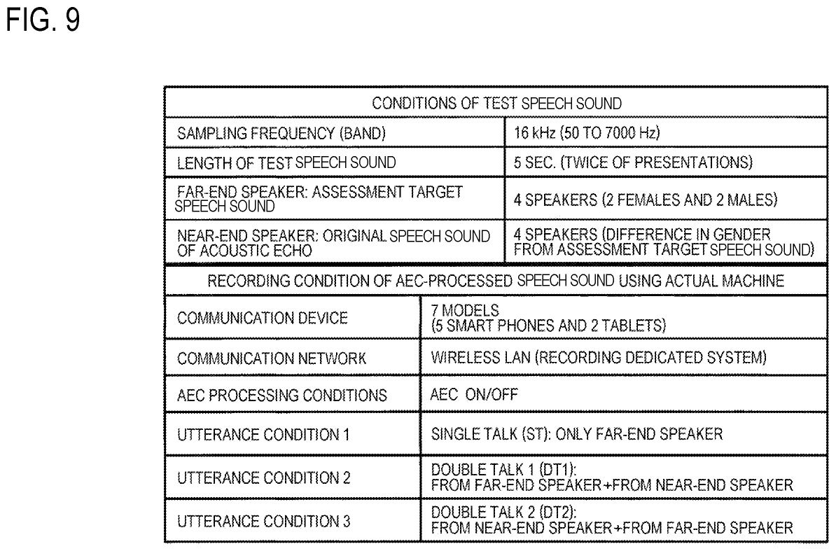

FIG. 9 is a table illustrating test conditions of the AEC processing by an actual machine. The test speech sounds used in this test were obtained in 168 conditions including four speakers (two females and two males)×seven communication devices×three types of utterance conditions×two AEC processing conditions (AEC ON/OFF). The test speech sounds were presented randomly, and a different presentation order was used for each subject set (set of four subjects). In order to simplify the conditions, the volume and the network delay were constant, and there was no packet loss. The test speech sound used here includes all influences of a mobile terminal, a transmission path, an encoding process, and the like and does not indicate performance of the AEC itself.

### <<Quality Assessment of AEC-Processed Speech Sound by Actual Machine>>

Here, speech sound that is an assessment target has a large quality difference as compared with <Quality Assessment for AEC-Processed speech sound Created by Computing Machine Simulation> and does not require high assessment accuracy. Therefore, the DCR was used in this test, and 24 ordinary people were employed as subjects.

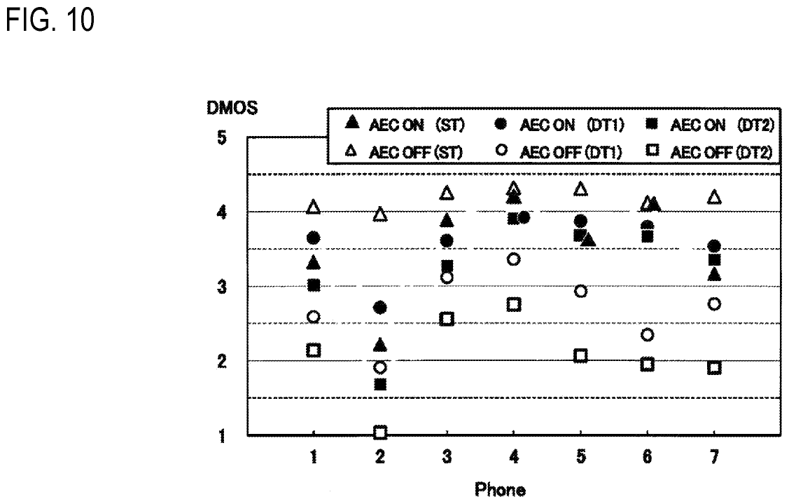

FIG. 10 illustrates a result of a listening test for the actual machine recorded speech sound. Here, the vertical axis represents a subjective evaluation value by the listening test (DMOS) according to the DCR, and the horizontal axis represents a communication device number. Each point on the graph is an evaluation value for each of the AEC processing condition and the utterance conditions, and the higher the point is positioned on the graph, the higher the quality is. Here, symbols of a black triangle and a white triangle indicate the single talk, symbols of a black circle and a white circle indicate double talk 1 (the far-end speaker talks first), and symbols of a black square and a white square indicate double talk 2 (the near-end speaker talks first). Here, black indicates a condition for performing the AEC processing (hereinafter, AEC ON), and white indicates a condition without performing the AEC processing (hereinafter, AEC OFF), and each point indicates an average value of 96 data (4 speakers×24 subjects).

The results of the proposed listening test according to the DCR is mostly consistent with theoretical results, and it can be found that the highest assessment in the condition of the “received speech sound of the single talk with AEC OFF” and the lowest assessment in the condition of the “received speech sound of double talk on which an acoustic echo with AEC OFF is superimposed” are obtained.

The graph illustrated here indicates a distribution of variations in speech quality which is the assessment target and does not indicate a performance difference of the AEC processing. Variations can be increased by including the AEC OFF conditions (received speech sound of the single talk, received speech sound of double talk on which the acoustic echo is superimposed) in the assessment target.

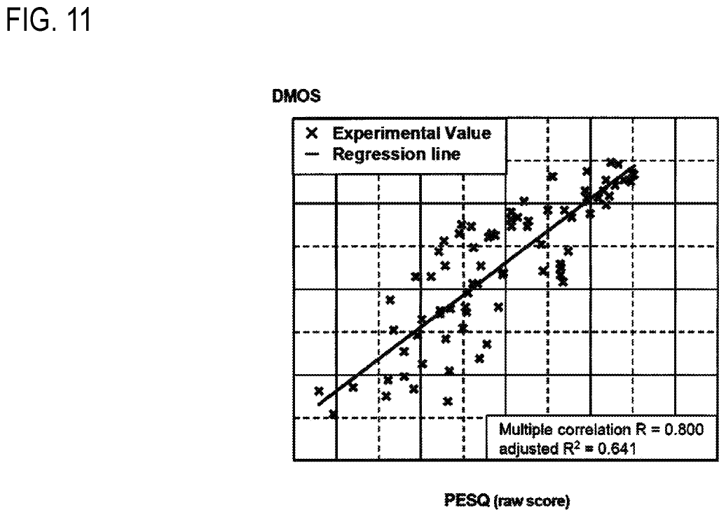

FIG. 11 illustrates a relationship between a DMOS and a PESQ evaluation value. Here, the vertical axis represents a DMOS, and the horizontal axis represents a PESQ evaluation value (raw score). Here, x represents an actual measured value of a DMOS and a PESQ evaluation value, and a solid line represents an estimation value (regression line) calculated by regression analysis. Here, items of the plotted data are 79 items of data obtained by removing five conditions of PESQ errors from an average value of seven communication devices×three types of utterance conditions×two AEC processing conditions×two speaker genders (male and female), and each point indicates an average value of 48 items of data (2 speakers for each gender×24 subjects).

From the results of the evaluation test, an adjusted coefficient R² of determination of an estimation model (hereinafter, DMOS estimation model) for actual measured values of the DMOS and the PESQ evaluation values was 0.71. This indicates that the DMOS estimation model is consistent with the measured value by 71%. Consequently, 71% of the variations of the DMOS can be explained, and it can be described that the proposed listening test DCR can be estimated from PESQ with high accuracy.

Further, as a result of detailed analysis of the five conditions of the PESQ error excluded from counting, it has been confirmed that there is a possibility that an error has occurred in the calculation of the PESQ evaluation value due to malfunction of a function of adjusting a “time shift between a reference signal and a degraded signal”, which is an internal function of PESQ, due to the presence of an unremoved residual acoustic echo. In addition, other conditions performed at the same time were analyzed, and it was confirmed that no malfunction occurred and a normal operation was performed when there was no time shift. It can be described that the “malfunction of the function of adjusting the time shift” occurring inside PESQ that has become clear here is a problem of PESQ evaluation (subjective evaluation value estimation) for a loudspeaker speech sound. This problem can be addressed by synchronizing the reference signal with the degraded signal in advance. For example, in a case where an adjustment error occurs even though synchronization has been performed in advance, a possibility of improving the subjective value estimation accuracy by eliminating the PESQ evaluation value has been found.

From the results of this test, as a result of performing the proposed listening test (DCR) on the AEC-processed speech sound as the target by the actual machine, it has been confirmed that a theoretical result can be obtained and a hypothesis is correct. In addition, the relationship between both the evaluation value obtained in the proposed listening test and the estimation value by PESQ was confirmed.

### Example 1

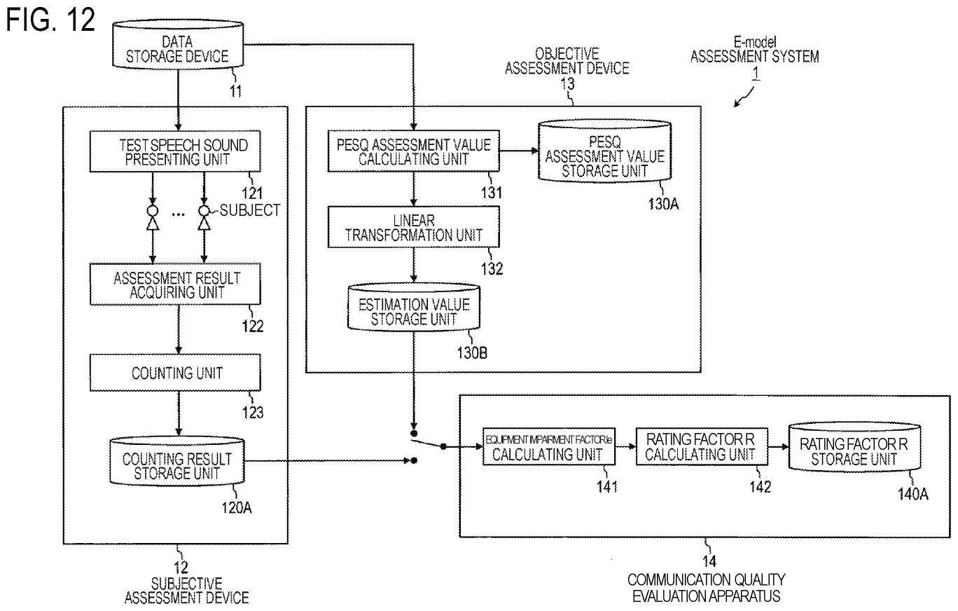

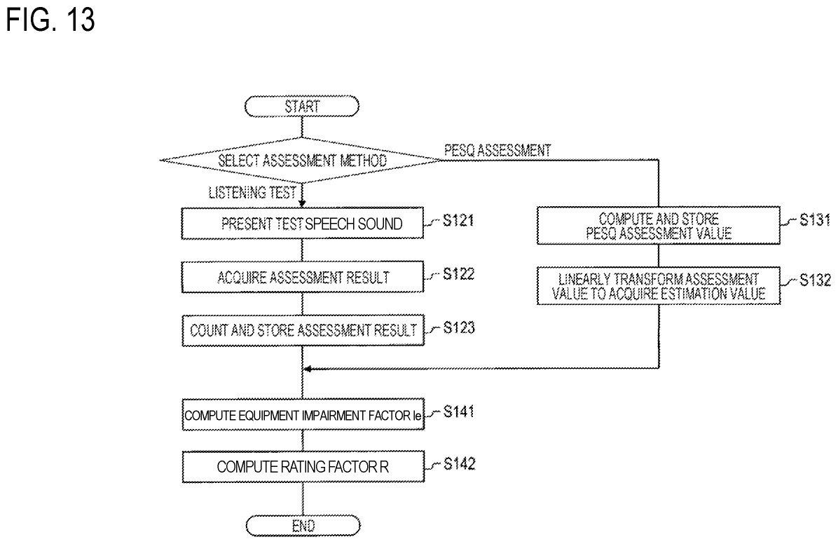

Hereinafter, the E-model assessment system of Example 1 capable of estimating the speech quality of a loudspeaker speech system by the E-model on the basis of the above-described research results will be described. A device configuration of the E-model assessment system according to the present example will be described with reference to FIG. 12. As illustrated in the drawing, the E-model assessment system 1 of the present example includes a data storage device 11, a subjective assessment device 12, an objective assessment device 13, and a communication quality evaluation apparatus 14. The subjective assessment device 12 includes test speech sound presenting unit 121, an assessment result acquiring unit 122, a counting unit 123, and a counting result storage unit 120A. The objective assessment device 13 includes a PESQ assessment value computing unit 131, a linear transformation unit 132, a PESQ assessment value storage unit 130A, and an estimation value storage unit 130B. The communication quality evaluation apparatus 14 includes an Equipment impairment factor Ie computing unit 141, a Rating factor R computing unit 142, and a Rating factor R storage unit 140A. Hereinafter, operations of each device and each component will be described with reference to FIG. 13.

### <Data Storage Device 11>

The data storage device 11 stores test speech sound in advance. Preferably, examples of the test speech sound include speech sound in N×M×P conditions by P speakers, the speech sound being obtained by superimposing N stages of speech sound distortions and M stages of residual echoes in a stagewise manner when N, M, and P are integers of 1 or more. N, M, and P can be set to any number. An example in which N=9, M=10, and P=4 is already illustrated in FIG. 4 and the corresponding description. Note that the test speech sound may include not only a computing machine-processed speech sound (speech sound distortion/acoustic echo) but also an “output speech sound of a communication device” and the like as the speech sound processed by the actual machine.

As illustrated in FIG. 4, if the test speech sound is test speech sound in which the speech sound distortion is superimposed in a stagewise manner by nine steps in increments of 6 dB in the range of SER: −6 to 42 dB and the residual echo is superimposed in a stagewise manner by ten stages in increments of 3 dB in the range of the SDR: 3 to 30 dB, it is preferable since it can be expected to acquire highly accurate assessment as illustrated in FIGS. 5 to 7.

### <Subjective Assessment Device 12>

Since the communication quality evaluation apparatus 14 to be described below is a device that computes the Rating factor R on the basis of the subjective evaluation values by the listening test or the PESQ value, a processing flow differs depending on whether the Rating factor R is computed on the basis of the subjective evaluation values by the listening test or the Rating factor R is computed on the basis of the PESQ value. First, a flow of the subjective evaluation device 12 in a case where the Rating factor R is computed on the basis of the subjective evaluation value by the listening test will be described.

### <Test Speech Sound Presenting Unit 121>

The test speech sound presenting unit 121 presents the test speech sound stored in the data storage device 11 to the subject (S121).

### <Assessment Result Acquiring Unit 122>

The assessment result acquiring unit 122 acquires an assessment result obtained by assessing the test speech sound by the subject on the basis of DCR or ITU-R BS.1116 on the basis of the subjective evaluation scale including both words indicating a difference in the test speech sound from the reference speech sound and words indicating listening easiness of the test speech sound (S122).

“Words indicating the difference in the test speech sound from the reference speech sound” are, for example, words such as a word having “no (imperceptible) difference from the reference speech sound” and a word having “a difference (discrepancy) from the reference speech sound”, and “words indicating the listening easiness of the test speech sound” are, for example, words such as a word “easy to listen”, a word “with no problem in listening”, a word “slightly difficult to hear”, a word “difficult to hear”, and a word “very difficult to hear”.

An example of the subjective evaluation scale including both “words indicating the difference in the test speech sound from the reference speech sound” and “words indicating the listening easiness of the test speech sound” has already been illustrated in FIG. 2.

As illustrated in FIG. 2, when the subjective evaluation scale includes “5: no perceptible difference from reference speech sound”, “4: perceptible difference but audible”, “3: perceptible difference and slightly inaudible”, “2: perceptible difference and barely audible”, and “1: perceptible difference and almost inaudible”, the subjective evaluation scale is preferable since acquisition of highly accurate assessment can be expected as illustrated in FIGS. 5 to 11.

### <Counting Unit 123>

The counting unit 123 counts the assessment results and stores the assessment results in the counting result storage unit 120A (S123).

### <Counting Result Storage Unit 120A>

The counting result storage unit 120A stores the assessment results acquired in step S122 and counted in step S123.

### <Objective Assessment Device 13>

Next, a flow of the objective assessment device 13 in a case where the Rating factor R is computed on the basis of the PESQ assessment value will be described.

### <PESQ Assessment Value Computing Unit 131>

The PESQ assessment value computing unit 131 computes the PESQ assessment value of the test speech sound and transmits the computed PESQ assessment value to the PESQ assessment value storage unit 130A (S131). For a computing example of the PESQ assessment value, an algorithm is strictly defined in ITU-T Recommendations P.862, and reference software is attached to the recommendations. FIG. 6 and the corresponding description have already been provided.

### <PESQ Assessment Value Storage Unit 130A>

The PESQ assessment value storage unit 130A stores the PESQ assessment value computed in step S131.

### <Linear Transformation Unit 132>

The linear transformation unit 132 linearly transforms the PESQ assessment value computed in step S131 on the basis of a regression expression obtained by regression analysis of the assessment result and the PESQ assessment value to acquire an estimation value of the subjective assessment value and stores the acquired estimation value in the estimation value storage unit 130B (S132). A computing example of the regression expression is already described in FIGS. 7 and 11 and the corresponding description.

### <Estimation Value Storage Unit 130B>

The estimation value storage unit 130B stores the estimation value of the subjective assessment value acquired in step S132.

### <Speech Quality Assessment Device 14>

Hereinafter, operations of the communication quality evaluation apparatus 14 in each flow of the listening assessment and PESQ assessment will be described.

### <Equipment Impairment Factor Ie Computing Unit 141 (Case of Listening Test)>

The Equipment impairment factor Ie computing unit 141 computes an Equipment impairment factor Ie in a Rating factor R calculating expression of the E-model on the basis of the assessment results (details thereof having been already described in step S122 and the like) obtained by assessing the test speech sounds by the subjects based on DCR or ITU-R BS.1116 based on the subjective evaluation scale including both the words indicating a difference in the test speech sound from reference speech sound and the words indicating the listening easiness of the test speech sounds (S141). The Equipment impairment factor Ie computing unit 141 can obtain the Equipment impairment factor Ie by using a conversion expression of ITU-T P.833 for the assessment results.

### <Equipment Impairment Factor Ie Computing Unit 141 (Case of PESQ Evaluation)>

The Equipment impairment factor Ie computing unit 141 computes the Equipment impairment factor Ie in the Rating factor R calculating expression of the E-model on the basis of the estimation value of the subjective assessment obtained by linearly converting the PESQ evaluation value of the test speech sound by using the regression expression obtained in advance for the evaluation result of the listening test and the PESQ evaluation value of the test speech sound (S141). The Equipment impairment factor Ie computing unit 141 can obtain the Equipment impairment factor Ie by using the conversion expression of ITU-T P.833 for the estimation value.

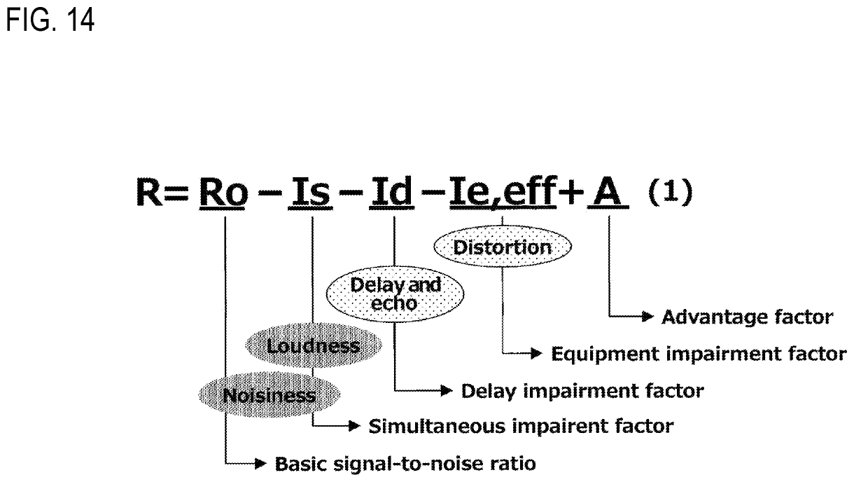

As illustrated in FIG. 14, the Equipment impairment factor Ie is a subjective evaluation value by the listening test of a codec, and eff represents information of a transmission error.

In addition, as described above, it is preferable that the subjective evaluation scale be configured to include “5: no perceptible difference from reference speech sound”, “4: perceptible difference but audible”, “3: perceptible difference and slightly inaudible”, “2: perceptible difference and barely audible”, and “1: perceptible difference and almost inaudible”.

In addition, as described above, it is preferable that the test speech sound include the speech sound in N×M×P conditions by P speakers, the speech sound being obtained by superimposing N stages of speech sound distortions and M stages of residual echoes in a stagewise manner when N, M, and P are integers of 1 or more.

### <Rating Factor R Computing Unit 142>

The Rating factor R computing unit 142 computes the Rating factor R of the E-model based on the computed Equipment impairment factor Ie and stores the Rating factor R in the Rating factor R storage unit 140A (S142).

<Rating factor R Storage Unit 140A>

The Rating factor R storage unit 140A stores the Rating factor R computed in step S142. <Supplementary Note>

The device according to the present invention includes, for example, as a single hardware entity, an input unit that can be connected to a keyboard or the like, an output unit that can be connected to a liquid crystal display or the like, a communication unit that can be connected to a communication device (e.g., a communication cable) capable of communicating with the outside of the hardware entity, a central processing unit (CPU which may include a cache memory or a register), a RAM or a ROM which is a memory, an external storage device as a hard disk, and a bus that connects the input unit, the output unit, the communication unit, the CPU, the RAM, the ROM, and the external storage device so that data can be exchanged therebetween. A device (drive) or the like that can write and read data in and from a recording medium such as a CD-ROM may be provided in the hardware entity, as necessary. Examples of a physical entity including such a hardware resource include a general-purpose computer and the like.

The external storage device of the hardware entity stores a program required to implement the above-described functions, data required to process the program, and the like (the present invention is not limited to the external storage device and the program may be stored, for example, in a ROM, which is a read-only storage device). Data or the like obtained by processing the program is appropriately stored in a RAM, an external storage device, or the like.

In the hardware entity, each program stored in the external storage device (or ROM or the like) and data required to process each program are read to a memory as necessary and are appropriately interpreted and processed by the CPU. As a result, the CPU implements a predetermined function (each component represented as . . . unit, . . . means, or the like).

The present invention is not limited to the above-described embodiments and can be appropriately modified without departing from the gist of the present invention. The processes described in the foregoing embodiment may be executed not only chronologically in accordance with the described order, but also in parallel or individually in accordance with the processing capability of a device that executes the processes or as necessary.

As described above, when the processing function of the hardware entity (the device according to the present invention) described in the foregoing embodiment is implemented by a computer, processing content of the function of the hardware entity is described by a program. In addition, as the computer executes the program, the processing function of the hardware entity is implemented on the computer.

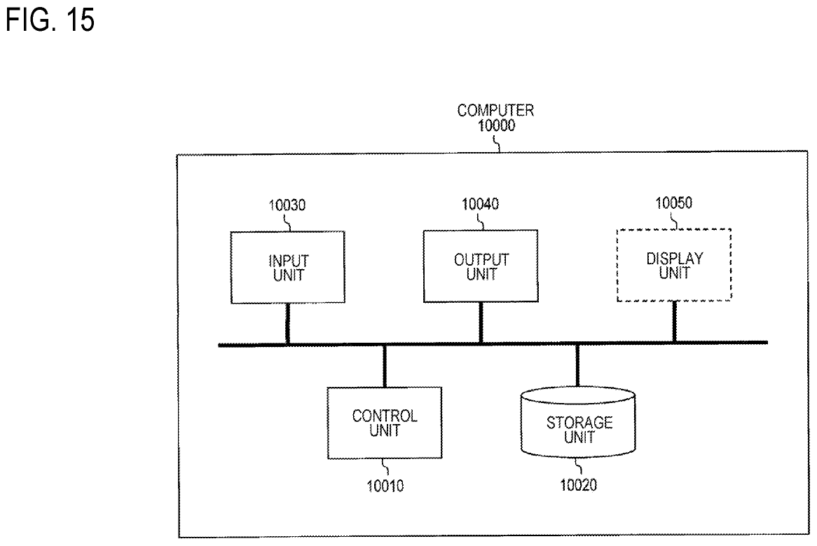

The various kinds of processing described above can be performed by causing a recording unit 10020 of a computer 10000 illustrated in FIG. 15 to read a program for executing each step of the method described above and causing a control unit 10010, an input unit 10030, an output unit 10040, and the like to operate.

The program in which the processing content is written may be recorded on a computer-readable recording medium. The computer-readable recording medium may be, for example, any recording medium such as a magnetic recording device, an optical disc, a magneto-optical recording medium, or a semiconductor memory. Specifically, for example, a hard disk device, a flexible disk, a magnetic tape, or the like can be used as the magnetic recording device, a digital versatile disc (DVD), a DVD random access memory (DVD-RAM), a compact disc read only memory (CD-ROM), a CD recordable/rewritable (CD-R/RW), or the like can be used as the optical disc, a magneto-optical disc (MO) or the like can be used as the magneto-optical recording medium, and an electrically erasable and programmable-read only memory (EEP-ROM) or the like can be used as the semiconductor memory.

In addition, the program is distributed by, for example, selling, transferring, or renting a portable recording medium such as a DVD or a CD-ROM on which the program is recorded. Further, the program may be stored in a storage device of a server computer, and the program may be distributed by transferring the program from the server computer to another computer via a network.

For example, a computer that executes such a program first temporarily stores a program recorded on a portable recording medium or a program transferred from the server computer in a storage device of the own computer. In addition, when executing processing, the computer reads the program stored in the recording medium of the own computer and executes the processing according to the read program. In addition, as another mode of the program, the computer may read the program directly from the portable recording medium and execute processing according to the program, or alternatively, the computer may sequentially execute processing according to a received program every time the program is transferred from the server computer to the computer. In addition, the above-described processing may be executed by a so-called application service provider (ASP) type service that implements a processing function only by an execution instruction and result acquisition without transferring the program from the server computer to the computer. Note that the program in the present embodiment includes information that is used for processing by an electronic computing machine and is equivalent to the program (data or the like that is not a direct command to the computer but has property that defines processing performed by the computer).

Although the hardware entity is configured by causing a computer to execute a predetermined program in the present embodiment, at least some of the processing content may be implemented by hardware.

1. A communication quality evaluation apparatus comprising:
processing circuitry configured to
compute an Equipment impairment factor Ie in a Rating factor R calculating expression of the E-model based on an assessment result obtained by assessing test speech sound by an subject based on DCR or ITU-R BS.1116 based on a subjective evaluation scale including both words indicating a difference in the test speech sound from reference speech sound and words indicating listening easiness of the test speech sound; and
compute a Rating factor R of the E-model based on the computed Equipment impairment factor Ie.

2. The communication quality evaluation apparatus according to claim 1, the processing circuitry configured to compute an Equipment impairment factor Ie in a Rating factor R calculating expression of the E-model based on an estimation value of subjective assessment obtained by linearly converting a PESQ evaluation value of the test speech sound by using a regression expression obtained in advance for the assessment result and the PESQ evaluation value of the test speech sound.

3. The communication quality evaluation apparatus according to claim 1, wherein the subjective evaluation scale includes “5: no perceptible difference from reference speech sound”, “4: perceptible difference but audible”, “3: perceptible difference and slightly inaudible”, “2: perceptible difference and barely audible”, and “1: perceptible difference and almost inaudible”.

4. The communication quality evaluation apparatus according to claim 1, wherein the test speech sound includes speech sound in N×M×P conditions by P speakers, which is obtained by superimposing N stages of speech sound distortions and M stages of residual echoes in a stagewise manner when N, M, and P are integers of 1 or more, or output speech sound of a communication device.

5. A communication quality evaluation method of steps executed by a communication quality evaluation apparatus, the method comprising:
an Equipment impairment factor Ie computing step of computing an Equipment impairment factor Ie in a Rating factor R calculating expression of the E-model based on an assessment result obtained by assessing test speech sound by an subject based on DCR or ITU-R BS.1116 based on a subjective evaluation scale including both words indicating a difference in the test speech sound from reference speech sound and words indicating listening easiness of the test speech sound; and
a Rating factor R computing step of computing a Rating factor R of the E-model based on the computed Equipment impairment factor Ie.

6. The communication quality evaluation method according to claim 5, wherein, in the Equipment impairment factor Ie computing step, an Equipment impairment factor Ie in a Rating factor R calculating expression of the E-model is computed based on an estimation value of subjective assessment obtained by linearly converting a PESQ evaluation value of the test speech sound by using a regression expression obtained in advance for the assessment result and the PESQ evaluation value of the test speech sound.

7. A non-transitory computer readable medium storing a computer program for causing a computer to function as the communication quality evaluation apparatus according to claim 1.
